(19) United States
(12) Patent Application Publication
(10) Pub. No.: US 2003/0065675 A1
(43) Pub. Date: Apr. 3, 2003

(54) Data converter

(76) Inventors: Ralph Gritzbach, Erlangen (DE); Rainer Kuth, Herzogenaurach (DE); Christoph Zindel, Uttenreuth (DE)

Correspondence Address: SCHIFF HARDIN & WAITE, 6600 SEARS TOWER, 233 S WACKER DR, CHICAGO, IL, 60606-6473, US

(21) Appl. No.: 10/228,662

(22) Filed: Aug. 27, 2002

(30) Foreign Application Priority Data
Aug. 27, 2001 (DE) 10141834.5

(51) Int. Cl. G06F 7/00

(52) U.S. Cl. 707/102

(57) ABSTRACT

A starting datafile is structured in a starting format and contains image data and text data allocated to the image data. The text data allocated to the image data are arranged in a header that precedes the image data. The starting datafile can be prescribed for a data converter that can generate an ending datafile structured in an ending format differing from the starting format on the basis of the starting datafile. It The ending datafile the image data. Which text data the data converter should transfer into the ending datafile is prescribed for the data converter.

### BACKGROUND OF THE INVENTION

1. Field of the Invention

The present invention is directed to a data converter of the type to which a starting datafile can be prescribed that is structured in a starting format and contains image data and text data allocated to the image data, with the text data are arranged in a header that precedes the image data, and the data converter can generate an ending datafile structured in an ending format on the basis of the starting datafile, with the ending format differing from the starting format and the ending datafile containing the image data.

2. Description of the Prior Art

A data converter of this type is disclosed, for example, in German OS 196 25 839.

Many datafiles in which image data are stored and employed in the field of medicine. These datafiles usually exhibit a format referred to as the DICOM format. This format is essentially characterized by an image header in a predetermined format, and the image header contains fields wherein data about the medical procedure with which the image was acquired are contained.

Browsers for applications beyond medicine do not support this format.

### SUMMARY OF THE INVENTION

An object of the present invention is to provide a data converter of the above type with which a conversion of these data for secondary applications is possible in a convenient, simple and dependable way.

This object is achieved in a data converter of the above type wherein the text data that should be accepted into the ending datafile can be prescribed to the data converter, and the data converter only transfers the prescribed text data into the ending datafile.

In an embodiment wherein text fields can be generated in the ending format, the text data to be accepted into the ending datafile are preferably transferred as text fields. Otherwise, they are transferred into the ending datafile as bit patterns.

In an embodiment the text data that the date converter is to accept into the ending datafile can be interactively prescribed for the data converter, the prescription is possible in an especially convenient way.

In an embodiment of the invention it can also be interactively prescribed as to how the text data to be accepted should be positioned relative to the image data, so the prescription is even more comfortable. The interactive prescription is especially simple when the data converter can display the text data allocated to the image data on an output device.

In an embodiment wherein the interactive prescription and/or the interactive positioning of the text data ensues with a drag & drop technique, then the prescription and the positioning are it is especially easy for a user. Broad segments of the population are already familiar with the drag & drop technique from PC applications.

In an embodiment wherein a pre-setting regarding which text data the data converter should transfer into the ending datafile can be prescribed for the data converter, the text data to be transferred need not be explicitly prescribed anew at each datafile. The pre-setting can co-define the positioning of the text data.

Preferably, the data converter can be given a block command. When the block command has been given, predetermined text data cannot be prescribed for transfer into the ending datafile. As a result, the data protection can be assured in a simple way (namely by blanking out person-specific data).

### DESCRIPTION OF THE DRAWINGS

FIG. 1 is a block diagram of a data converter in accordance with the invention.

FIG. 2 illustrates an image data of a starting datafile in accordance with the invention.

FIG. 3 illustrates text data of a starting datafile in accordance with the invention.

FIG. 4 is an illustration of an ending datafile in accordance with the invention

### DESCRIPTION OF THE PREFERRED EMBODIMENTS

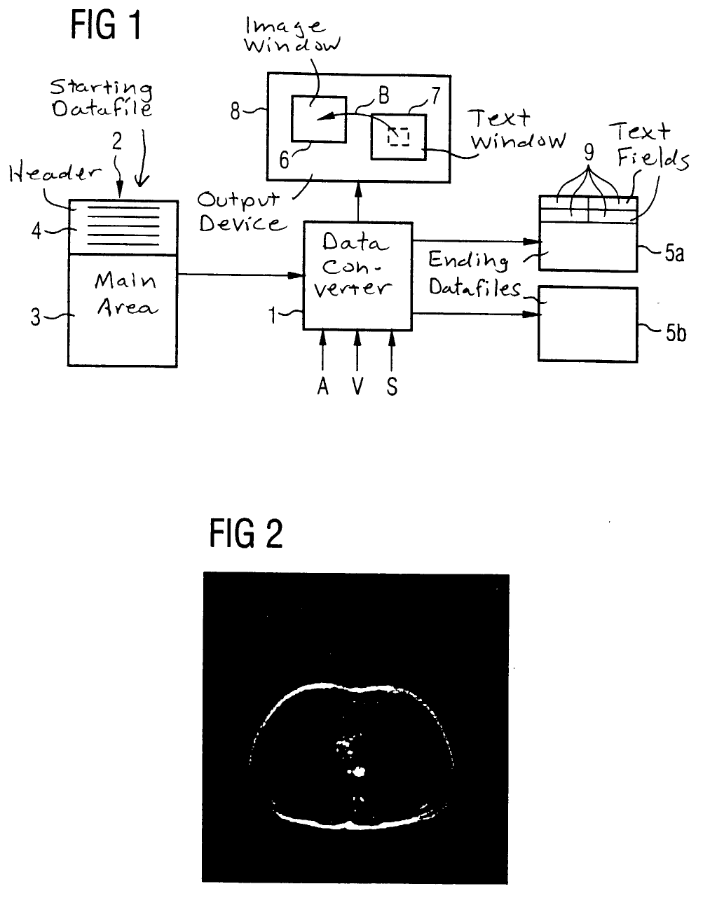

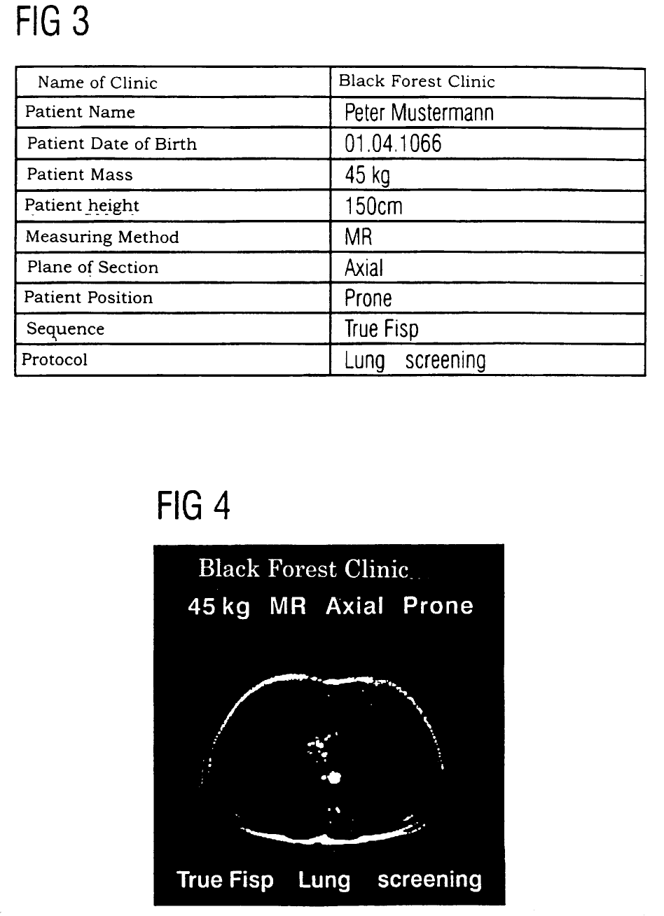

As shown in FIG. 1, a starting datafile 2 can be prescribed for a data converter 1. The starting datafile 2 is structured in a starting format, namely the DICOM format. It therefore comprises a main area 3 and a header 4 that precedes the main area 3. Image data are stored in the main area 3. As an example, FIG. 2 shows a reconstruction of the image data of the main area 3. Text data allocated to the image data are deposited in the header 4. FIG. 3 shows an example of the allocated text data.

The data converter 1 can generate an ending datafile 5a or 5b on the basis of the starting datafile 2. The ending datafiles 5a, 5b are constructed in ending formats that differ from the starting format. The ending datafiles 5a, 5b contain the image data from the main area 3 of the starting datafile 2 as well as some of the text data from the header 4.

Before the ending datafile 5a or, respectively, 5b is generated, the data converter 1 displays the image data in an image window 6 and the text data allocated to the image data in a text window 7 on an output device 8. A user (not shown for the sake of clarity) can interactively prescribe selection commands B for the data converter 1. Individual text data are selected on the basis of the selection commands B. Which of the text data the data converter 1 should transfer into the ending datafile 5a or 5b thus can be prescribed for the data converter 1. Only the prescribed text data are then in fact transferred into the ending datafile 5a or, respectively, 5b by the data converter 1.

The selection and thus the interactive prescription of the text data preferably ensue by means of a drag & drop mechanism. This is indicated in FIG. 1 with an arrow B that proceeds from an individual text datum that is indicated with broken lines and is thus indicated as selected.

The drag & drop mechanism also simultaneously determines how the data converter 1 should position the text data to be transferred relative to the image data. The positioning thus is also interactively prescribed for the data converter 1 with the drag & drop mechanism.

An example of an image datafile produced in this way is shown in FIG. 4. According to FIG. 4, the ending datafile 5a or 5b contains the selected text data in addition to the actual image data.

When text fields 9 can be generated in the ending format, the text data to be transferred into the ending datafile are preferably transferred as such text fields 9. This is shown as an example in FIG. 1 for the ending datafile 5a. Alternatively, the text data are transferred into the ending datafile as bit patterns, so that a single, uniform ending datafile is derived therefrom. This is shown as an example in FIG. 1 for the ending datafile 5b, which contains no text fields.

In addition to the selection commands A, a block command S and/or a pre-setting V can be prescribed for the data converter 1.

When the block command S is prescribed for the data converter, then predetermined text data can no longer be selected, i.e., they can no longer be transferred into the ending datafile 5a or 5b. In particular, these are the person-specific data of name and date of birth. With respect to the date of birth, it can suffice to blank out the birth day and/or the birth month if the approximate age of the patient for which the image was generated is significant.

Which of the text data the data converter 1 should transfer into the ending datafile 5a or 5b can be set in advance with the pre-setting V. As a result, the user is relieved of a tedious individual entries for the starting datafile 2 to be converted.

The inventive data converter 1 enables a simple and flexible conversion of starting datafiles 2 into ending datafiles 5a, 5b having a different format, since the inventive data converter 1 is able to selectively transfer text data that are already present in the starting datafile 2 into the ending datafile 5a or 5b. In contrast, regenerating text data is not possible with the data converter 1.

Although modifications and changes may be suggested by those skilled in the art, it is the intention of the inventors to embody within the patent warranted hereon all changes and modifications as reasonably and properly come within the scope of their contribution to the art.

We claim as our invention:

1. A data converter comprising:
a conversion unit for which a starting datafile is prescribed, said starting datafile being structured in a starting format and containing image data and text data allocated to the image data, said text data allocated to the image data being disposed in a header preceding said image data, said conversion unit generating an ending data file structured in an ending format, differing from said starting format, from said starting datafile, said ending datafile containing said image data; and
a user interface allowing a designation of which of said text data said conversion unit should transfer into said ending datafile, and said conversion unit transferring only the designated text data into said ending data file.

2. A data converter as claimed in claim 1 wherein said starting format of said starting datafile is the DICOM format.

3. A data converter as claimed in claim 1 wherein said conversion unit generates text fields in said ending format with said designated text data being transferred into said text fields of said ending datafile.

4. A data converter as claimed in claim 1 wherein said conversion unit transfers said text data into said ending datafile as a bit pattern.

5. A data converter as claimed in claim 1 wherein said user interface allows said designated text data to be interactively prescribed for transfer into said ending datafile.

6. A data converter as claimed in claim 1 wherein said user interface allows said text data that are to be positioned relative to said image data to be interactively prescribed.

7. A data converter as claimed in claim 6 wherein said user interface comprises an output device for displaying said text data allocated to said image data.

8. A data converter as claimed in claim 6 wherein said user interface allows interactive prescription of said text data with a drop and drag technique via said output device.

9. A data converter as claimed in claim 1 wherein said user interface allows said text data that are to be positioned relative to said image data to be interactively positioned.

10. A data converter as claimed in claim 7 wherein said user interface comprises an output device for displaying said text data allocated to said image data.

11. A data converter as claimed in claim 7 wherein said user interface allows interactive positioning of said text data with a drop and drag technique via said output device.

12. A data converter as claimed in claim 1 wherein said user interface allows a pre-setting of said designated text data.

13. A data converter as claimed in claim 1 wherein said user interface allows prescription of a block command for said conversion unit which precludes a predetermined portion of said text data from being designated for transfer into said ending datafile.
